(19) United States
(12) Patent Application Publication
(10) Pub. No.: US 2025/0196671 A1
(43) Pub. Date: Jun. 19, 2025

(54) CONTROL DEVICE

(71) Applicant: TOYOTA JIDOSHA KABUSHIKI KAISHA, Toyota-shi (JP)

(72) Inventor: Jin KOBAYASHI, Nagoya-shi (JP)

(73) Assignee: TOYOTA JIDOSHA KABUSHIKI KAISHA, Toyota-shi (JP)

(21) Appl. No.: 18/894,430

(22) Filed: Sep. 24, 2024

(30) Foreign Application Priority Data
Dec. 19, 2023 (JP) 2023-213731

(51) Int. Cl. B60L 53/16; B60L 53/10; E05B 81/56; E05B 83/28; E05F 15/70

(52) U.S. Cl. CPC B60L 53/16; B60L 53/11; E05B 81/56; E05B 83/28; E05F 15/70; E05Y 2900/534

(57) ABSTRACT

ECU is a control device that controls the charge of electrified vehicle. Electrified vehicle includes an AC inlet, a first lid for closing AC inlet, an AC/DC inlet, and a second lid for closing AC/DC inlet. ECU locks the other lid when the lid of one of the first lid and the second lid is opened. In this way, it is possible to avoid a state in which the plurality of lids are opened.

### CROSS-REFERENCE TO RELATED APPLICATION

This application claims priority to Japanese Patent Application No. 2023-213731 filed on Dec. 19, 2023, incorporated herein by reference in its entirety.

### BACKGROUND

### 1. Technical Field

The present disclosure relates to a control device, and more particularly, to a control device that controls charging of a vehicle.

### 2. Description of Related Art

Conventionally, there has been a charging system that forbids charging when a plurality of lids respectively provided to a plurality of inlets for charging is open (e.g., see Japanese Unexamined Patent Application Publication No. 2022-039337 (JP 2022-039337 A)).

### SUMMARY

However, a user feels inconvenienced, since charging cannot be performed when the lids are open.

This disclosure provides a control device capable of circumventing a situation in which users feel inconvenienced due to charging not being able to be performed.

A control device according to this disclosure is a control device for controlling charging of a vehicle. The vehicle includes a first inlet, a first lid for closing the first inlet, a second inlet, and a second lid for closing the second inlet. When one lid of the first lid and the second lid is opened, the control device places the other lid in a locked state.

According to such a configuration, a state in which multiple lids are opened can be circumvented. As a result, a control device can be provided that is capable of circumventing a situation in which the user feels inconvenienced because charging cannot be performed.

When the one lid is closed, the control device may place the other lid in an unlocked state.

According to such a configuration, a state in which multiple lids are opened can be circumvented. As a result, a situation can be circumvented in which the user feels inconvenienced because charging cannot be performed.

According to another aspect of this disclosure, a control device is a control device for controlling charging of a vehicle. The vehicle includes a first inlet, a first lid for closing the first inlet, a second inlet, and a second lid for closing the second inlet. When one lid of the first lid and the second lid is opened, and the other lid is open, the control device automatically closes the other lid.

According to such a configuration, a state in which multiple lids are opened can be circumvented. As a result, a control device can be provided that is capable of circumventing a situation in which the user feels inconvenienced because charging cannot be performed.

The control device may, following closing the other lid, place the other lid in a locked state. According to such a configuration, a state in which multiple lids are opened can be further circumvented. As a result, a situation can be circumvented in which the user feels inconvenienced because charging cannot be performed.
the first inlet may be for single-phase alternating current charging, and the second inlet may be for both single-phase alternating current charging and direct current charging.
   The first inlet may include a first terminal that is one terminal of a live terminal and a neutral terminal for single-phase alternating current, and a second terminal that is the other terminal.
   The second inlet may include a third terminal that serves as both a positive terminal for direct current and the one terminal, and a fourth terminal that serves as both a negative terminal for direct current and the other terminal.
   The first terminal and the second terminal may electrically conduct with the third terminal and the fourth terminal, respectively.

According to such a configuration, even when the first inlet and the second inlet are electrically conducting, a state in which multiple lids are opened can be circumvented. Accordingly, even when charging voltage is applied to one of the first inlet and the second inlet, a situation in which the user is affected by the charging voltage applied to the other inlet can be circumvented, since the lid of the other inlet is closed.

According to this disclosure, a control device can be provided that is capable of circumventing a situation in which the user feels inconvenienced because charging cannot be performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an entire configuration diagram of an electrified vehicle in which a battery system according to this embodiment is mounted;

FIG. 2 is a flowchart illustrating a flow of a part of a process of controlling charging of a vehicle according to the first embodiment;

FIG. 3 is a flow chart showing a flow of a part of a process of controlling charging of vehicles in the second embodiment; and

FIG. 4 is a flowchart illustrating a flow of a part of a process of controlling charging of a vehicle according to the third embodiment.

### DETAILED DESCRIPTION OF EMBODIMENTS

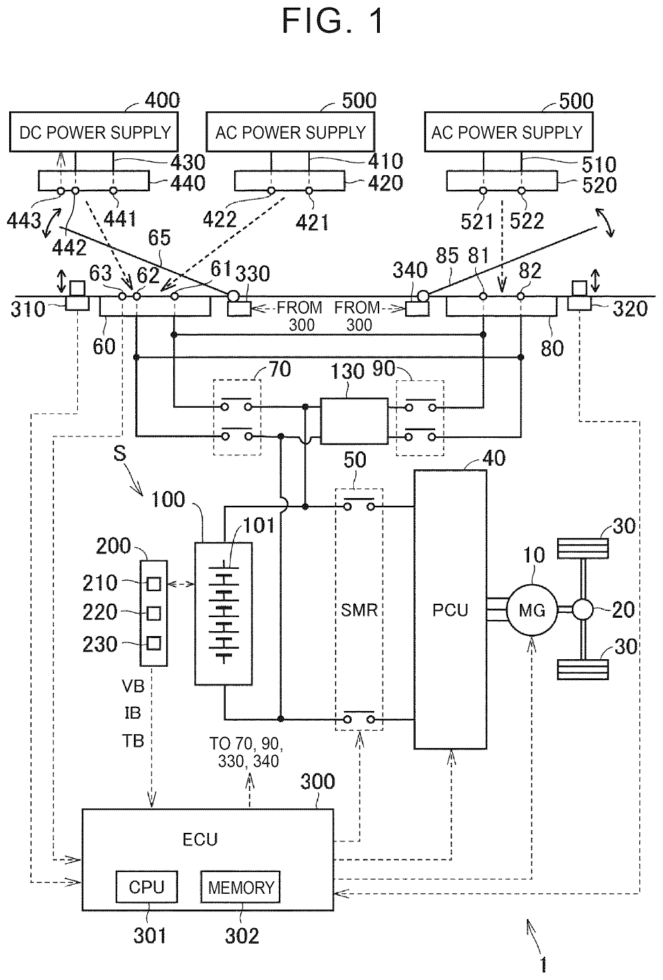

FIG. 1 is an entire configuration diagram of an electrified vehicle 1 in which a battery system S according to this embodiment is mounted. In this embodiment, electrified vehicle 1 is, for example, battery electric vehicle. Electrified vehicle 1 includes a motor generator (MG) 10 which is a rotary electric machine, power transmission gears 20, drive wheels 30, a power control unit (PCU) 40, a system main relay (SMR) 50, a battery 100, a monitoring unit 200, and an electronic control unit (ECU) 300 which is an exemplary control device.

MG 10 is, for example, an embedded-structure permanent-magnet synchronous motor (IPM motor), and has a function as an electric motor and a function as a generator. The output-torque of MG 10 is transmitted to the drive wheels 30 via the power transmission gears 20 including a speed reducer, a differential, and the like.

When electrified vehicle 1 is braked, MG 10 is driven by the drive wheels 30, and MG 10 operates as a generator. As a result, MG 10 also functions as a braking device that performs regenerative braking for converting kinetic energy of electrified vehicle 1 into electric power. Regenerated electric power generated by regenerative braking force in the MG 10 is stored in the battery 100.

The PCU 40 is a power conversion device that bidirectionally converts electric power between the MG 10 and the battery 100. The PCU 40 includes an inverter and a converter that operate, for example, based on a control signal from the ECU 300.

When the battery 100 is discharged, the converter steps up voltage supplied from the battery 100 and supplies the stepped-up voltage to the inverter. The inverter converts DC power which is supplied from the converter into AC power and drives the MG 10.

On the other hand, when the battery 100 is charged, the inverter converts AC power generated by MG 10 into DC power and supplies the DC power to the converter. The converter steps down voltage supplied from the inverter to voltage suitable for charging the battery 100 and supplies the stepped-down voltage to the battery 100.

The SMR 50 is electrically connected to power lines connecting the battery 100 and the PCU 40. If SMR 50 is ON (i.e., conductive) in response to a control signal from ECU 300, power may be transferred between the battery 100 and PCU 40. On the other hand, when SMR 50 is OFF (i.e., disconnected) in response to a control signal from ECU 300, the battery 100 is disconnected from PCU 40.

The battery 100 stores electric power for driving MG 10. The battery 100 is a rechargeable DC power source (secondary battery), and is an assembled battery in which a plurality of unit cells (battery cells) 101 is stacked and electrically connected in series, for example. The unit cells 101 may be composed of, for example, a lithium-ion battery.

The monitoring unit 200 includes a voltage detection unit 210, a current sensor 220, and a temperature sensor 230. The voltage detection unit 210 detects the voltage VB of the unit cells 101 (the voltage VB between the terminals of the unit cells 101). The current sensor 220 detects a current IB input to and output from the battery 100 (unit cells 101). The temperature sensor 230 detects a temperature TB of each of the cells 101. The detecting units output the results of this detection to the ECU 300.

Electrified vehicle 1 includes an AC/DC inlet 60. By using AC/DC inlet 60, the battery 100 can be rapidly charged from an external DC power supply 400, which is a charging facility that supplies direct current (DC) power. In addition, by using AC/DC inlet 60, the battery 100 can be normally charged from an external AC power supply 500, which is a charging facility that supplies single-phase alternating current (AC) power. AC/DC inlet 60 is configured to be connectable to a connector 440 provided at a distal end of the charging cable 430 of the external DC power supply 400 and a connector 420 provided at a distal end of the charging cable 410 of the external AC power supply 500. The terminal 61 of AC/DC inlet 60 is connected to the terminal 421 of the connector 420 and the terminal 441 of the connector 440. The terminals 61, 421, 441 are each also used as a single-phase AC live terminal and a DC positive terminal. The terminal 62 of AC/DC inlet 60 is connected to the terminal 422 of the connector 420 and the terminal 442 of the connector 440. The terminals 62, 422, 442 are each also used as a single-phase alternating current neutral terminal and a direct current negative terminal. The terminal 63 of AC/DC inlet 60 is connected to the terminal 443 of the connector 440. The terminals 63, 443 are each a terminal of a signal line for communication between ECU 300 and a control device of DC power supply 400. As AC/DC inlet 60 and the connector 420,440, for example, one conforming to the North American Charging Standard (NACS) can be adopted.

Electrified vehicle 1 comprises an AC inlet 80. By using AC inlet 80, the battery 100 can be normally charged from AC power supply 500. AC inlet 80 is configured to be connectable to a connector 520 provided at a distal end of the charge cable 510 of the external AC power supply 500. The terminal 81 of AC inlet 80 is connected to the terminal 521 of the connector 520. The terminals 81, 521 are each a single-phase AC live terminal. The terminal 82 of AC inlet 80 is connected to the terminal 522 of the connector 520. The terminals 82, 522 are each a single-phase alternating current neutral terminal. As AC inlet 80 and the connector 520, for example, inlets and connectors compliant with SAE (Society of Automotive Engineers) J1772 or the IEC (International Electrotechnical Commission) 62196-2 Type 1, or AC_Type 1, 2 that are respectively the AC portions of CCS (Combined Charging System) Type-1, 2.

The charging relay 70 is electrically connected to a power line connecting AC/DC inlet 60 and the battery 100. An in-vehicle charger 130 is provided in a power line between AC inlet 80 and the battery 100, and converts AC power supplied from an external AC power supply 500 into DC power and converts the battery 100 into a chargeable voltage. The charging relay 90 is electrically connected to a power line connecting AC inlet 80 and the in-vehicle charger 130. The two power lines connecting AC/DC inlet 60 and the charging relay 70 are connected to two power lines connecting AC inlet 80 and the charging relay 90, respectively, by two power lines so as to be able to conduct. As described above, since AC inlet 80 is electrically connected to AC/DC inlet 60, AC inlet 80 is also provided with the same measures as those for protecting the user of AC/DC inlet 60 and the high-voltage against waterproofing and dustproofing.

During rapid charging, the charging relay 70 switches between supplying and shutting off DC power between AC/DC inlet 60 and the battery 100 in response to a control signal from ECU 300. When the charging relay 70 is closed, external charging (quick charging) of the battery 100 is performed. During normal charging, the charging relay 90 switches between supplying and shutting off AC power between AC/DC inlet 60 or AC inlet 80 and the in-vehicle charger 130 in response to a control signal from ECU 300. When the charging relay 90 is closed, external charging (normal charging) of the battery 100 is performed.

AC/DC inlet 60 includes a lid 65, a courtesy switch 310, and a lid lock device 330. The lid 65 closes AC/DC inlet 60 from the outside in the closed state, while the connector 420,440 is connectable to AC/DC inlet 60 in the open state. The courtesy switch 310 is pushed in the closed state of the lid 65 and outputs a signal to ECU 300 indicating the closed state. On the other hand, the courtesy switch 310 is not pushed in the open state of the lid 65, and outputs a signal indicating that the lid is in the open state to ECU 300. The lid lock device 330 includes a locking mechanism that is controlled by ECU 300 to cause the lid 65 to be in a non-releasable locked state or a releasable unlocked state when the lid 65 is closed.

AC inlet 80 includes a lid 85, a courtesy switch 320, and a lid lock device 340. The lid 85 closes AC inlet 80 from the outside in the closed state, while the connector 520 is connectable to AC inlet 80 in the open state. The courtesy switch 320 is pushed in the closed state of the lid 85 and outputs a signal to ECU 300 indicating the closed state. On the other hand, the courtesy switch 320 is not pushed in the open state of the lid 85, and outputs a signal indicating that the lid is in the open state to ECU 300. The lid lock device 340 includes a locking mechanism that is controlled by ECU 300 to cause the lid 85 to be in a non-releasable locked state or a releasable unlocked state when the lid 85 is closed.

The ECU 300 includes a central processing unit (CPU) 301, and a memory (including, for example, a read only memory (ROM) and a random access memory (RAM)) 302. ECU 300 controls the respective devices so that electrified vehicle 1 is in a desired condition based on a signal received from the monitoring unit 200, a signal (for example, an accelerator operation amount signal, a vehicle speed signal, and the like) from various sensors (not shown), a map and a program stored in the memory 302, and the like. The battery system S includes a battery 100 (unit cells 101), a monitoring unit 200, an ECU 300, and the like.

In the above-described electrified vehicle 1, it is conceivable to prohibit charging when the plurality of lids 65, 85 provided in AC/DC inlet 60 and AC inlet 80, which are the plurality of inlets for charging, are open. However, when the plurality of lids 65, 85 are open, charging cannot be performed, so that the user feels inconvenience.

Thus, ECU 300 locks the other lid when one of the first lid 65 and the second lid 85 is opened. In this way, it is possible to avoid a state in which the plurality of lids are opened. As a result, it is possible to prevent the user from feeling inconvenience because charging cannot be performed.

### First Embodiment

In this embodiment, if not only the lid to be used, but also the unused lid is open, i.e., the plurality of lids are open, ECU 300 disables charging (e.g., shuts off the charging relay 90).

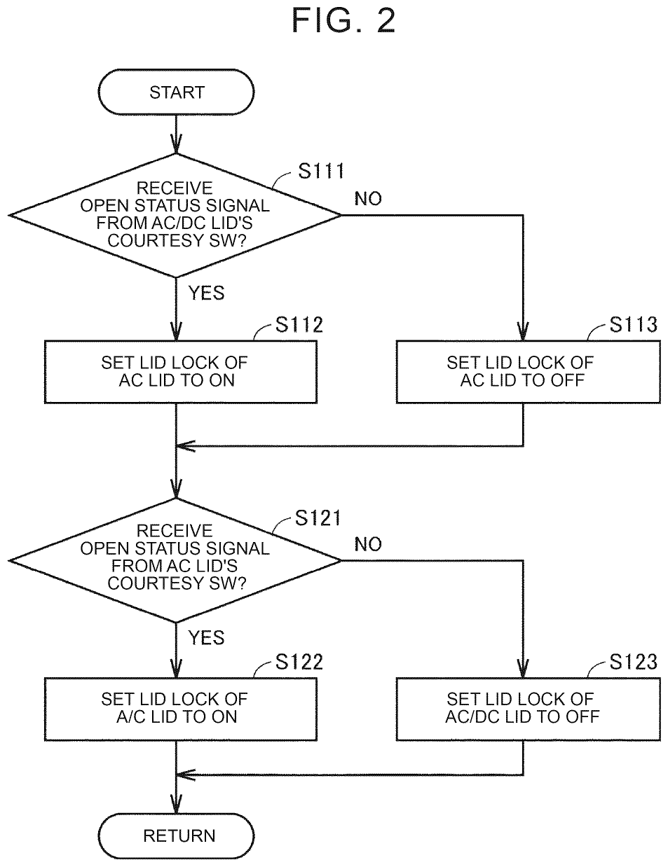

FIG. 2 is a flowchart illustrating a flow of a part of a process of controlling charging of a vehicle according to the first embodiment. Referring to FIG. 2, this process is called and executed by CPU 301 of ECU 300 at every predetermined cycle from the higher-order process.

First, it is determined whether or not a signal indicating that the lid 65 is open is received from the courtesy switch 310 of the lid 65 of AC/DC inlet 60 (S111). If CPU 301 determines that it has received (YES in S111), it turns on, i.e., locks, the lid lock device 340 of the lid 85 of AC inlet 80 (S112). On the other hand, if it is determined that there is no reception (NO in S111), CPU 301 turns off, that is, unlocks, the lid lock device 340 of the lid 85 of AC inlet 80 (S113).

After S112 and S113, CPU 301 determines whether it has received a signal from the courtesy switch 320 of the lid 85 of AC inlet 80 indicating that the lid 85 is open (S121). If CPU 301 determines that it has received (YES in S121), it turns on, i.e., locks, the lid lock device 330 of the lid 65 of AC/DC inlet 60 (S122). On the other hand, if it is determined that there is no reception (NO in S121), CPU 301 turns off, that is, unlocks, the lid lock device 330 of the lid 65 of AC/DC inlet 60 (S123). After S122 and S123, CPU 301 returns the processing to be executed to the processing of the upper level of the caller of this processing.

### Second Embodiment

In the first embodiment, the process when the lid 65, 85 is open is received from the courtesy switch 310 of AC/DC inlet 60 and the courtesy switch 320 of AC inlet 80, respectively. In the second embodiment, the process when the lid 65, 85 is closed is received from the courtesy switch 310 of AC/DC inlet 60 and the courtesy switch 320 of AC inlet 80, respectively.

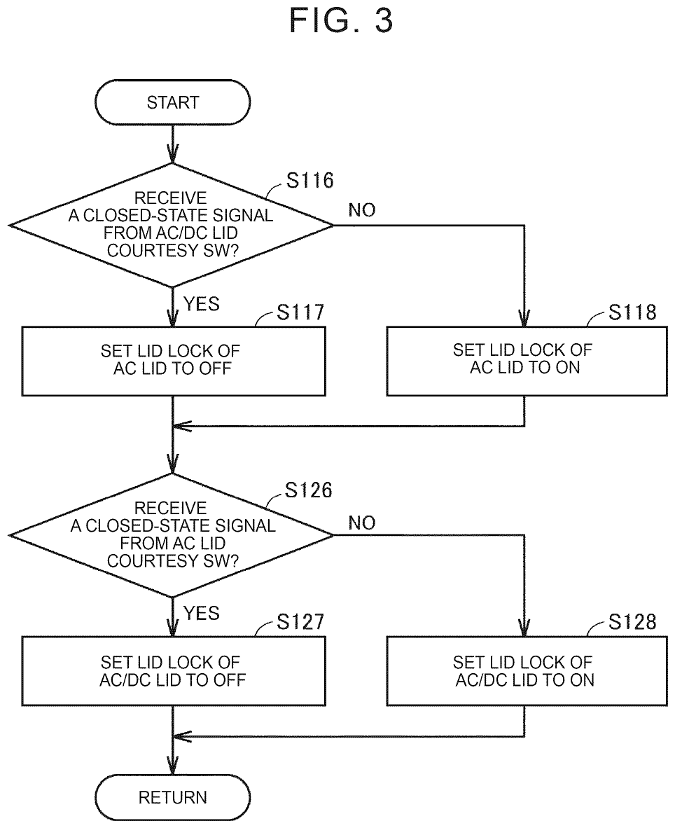

FIG. 3 is a flowchart illustrating a flow of a part of a process of controlling charging of a vehicle according to the second embodiment. Referring to FIG. 3, this process is called and executed by CPU 301 of ECU 300 at every predetermined cycle from the higher-order process.

First, it is determined whether or not a signal indicating that the lid 65 is closed is received from the courtesy switch 310 of the lid 65 of AC/DC inlet 60 (S116). If CPU 301 determines that it has received (YES in S116), it turns off, i.e., unlocks, the lid lock device 340 of the lid 85 of AC inlet 80 (S117). On the other hand, if it is determined that there is no reception (NO in S116), CPU 301 turns on—that is, locks the lid lock device 340 of the lid 85 of AC inlet 80 (S118).

After S117 and S118, CPU 301 determines whether it has received a signal from the courtesy switch 320 of the lid 85 of AC inlet 80 indicating that the lid 85 is closed (S126). If CPU 301 determines that it has received (YES in S126), it turns off, i.e., unlocks, the lid lock device 330 of the lid 65 of AC/DC inlet 60 (S127). On the other hand, if it is determined that there is no reception (NO in S126), CPU 301 turns on, that is, locks, the lid lock device 330 of the lid 65 of AC/DC inlet 60 (S128). After S127 and S128, CPU 301 returns the processing to be executed to the processing of the upper level of the caller of this processing.

### Third Embodiment

In the first embodiment and the second embodiment, when one lid is in the open state, the other lid is in the locked state. In the third embodiment, when one lid is opened and the other lid is opened, the other lid is automatically closed and the other lid is locked.

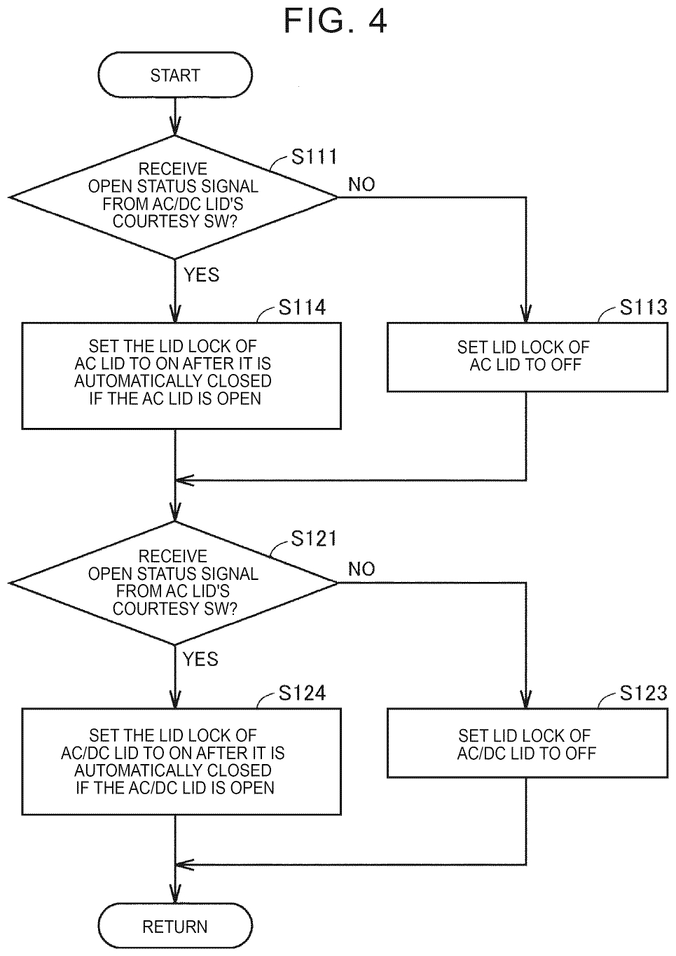

FIG. 4 is a flowchart illustrating a flow of a part of a process of controlling charging of a vehicle according to the third embodiment. Referring to FIG. 4, this process is called and executed by CPU 301 of ECU 300 at every predetermined cycle from the higher-order process. In FIG. 4, since the processing with the same step number as in FIG. 2 of the first embodiment is the same processing as in FIG. 2, the overlapping description will not be repeated.

In the third embodiment, the lid lock device 330,340 includes, in addition to the above-described locking mechanism, an opening/closing mechanism that automatically opens/closes the lid 65 and the lid 85 by being controlled by CPU 301 of ECU 300.

If it is determined that a signal indicating that the lid 65 is in the open state is received from the courtesy switch 310 of the lid 65 of AC/DC inlet 60 (YES in S111), CPU 301 controls the opening and closing mechanism of the lid lock device 340 of the lid 85 to automatically close if the lid 85 of AC inlet 80 is open, and then turns on, that is, the locking mechanism of the lid lock device 340 (S114).

If it is determined that a signal indicating that the lid 85 is in the open state is received from the courtesy switch 320 of the lid 85 of AC inlet 80 (YES by S121), CPU 301 controls the opening and closing mechanism of the lid lock device 330 of the lid 65 to automatically close if the lid 65 of AC/DC inlet 60 is open, and then turns on, that is, the locking mechanism of the lid lock device 330 (S124).

### Modifications

(1) In the above-described embodiment, the lid lock devices 340, 330 of AC inlet 80 and AC/DC inlet 60 are unlocked by S113 and S123 of FIG. 2, respectively. In addition, the lid lock devices 340, 330 of AC inlet 80 and AC/DC inlet 60 are unlocked by S117 and S127 of FIG. 3, respectively. However, the present disclosure is not limited thereto, and nothing may be executed in S113, S123, S117 and S127.

(2) In the third embodiment, the lid lock devices 330, 340 include an opening/closing mechanism in addition to the locking mechanism. However, the present disclosure is not limited thereto, and the lid lock devices 330, 340 may not include a lock mechanism, but may include an opening/closing mechanism.

(3) The above-described embodiments can be regarded as disclosure of a control device such as an ECU 300 or a vehicle such as an electrified vehicle 1 including a control device, and can be regarded as disclosure of a control device or a control method or a control program of the vehicle.

### SUMMARY

(1) As shown in FIG. 1, ECU 300 is a control device that controls the charge of electrified vehicle 1. As shown in FIG. 1, electrified vehicle 1 includes a first inlet (e.g., AC inlet 80), a first lid (e.g., lid 85) for closing the first inlet, a second inlet (e.g., AC/DC inlet 60), and a second lid (e.g., lid 65) for closing the second inlet. As shown in FIGS. 2 to 4, ECU 300 locks the other lid when the lid of one of the first lid and the second lid is opened (e.g., S112, S122 of FIG. 2, S118, S128 of FIG. 3, S114, S124 of FIG. 4).

In this way, it is possible to avoid a state in which the plurality of lids are opened. As a result, it is possible to prevent the user from feeling inconvenience because charging cannot be performed.

(2) As shown in FIGS. 2 to 4, ECU 300 may unlock the other lid when one lid is closed (e.g., S113, S123 of FIGS. 2 to 4, S117, S127 of FIG. 3).

In this way, it is possible to avoid a state in which the plurality of lids are opened. As a result, a situation can be circumvented in which the user feels inconvenienced because charging cannot be performed.

(3) As shown in FIG. 1, ECU 300 is a control device that controls the charge of electrified vehicle 1. As shown in FIG. 1, electrified vehicle 1 includes a first inlet (e.g., AC inlet 80), a first lid (e.g., lid 85) for closing the first inlet, a second inlet (e.g., AC/DC inlet 60), and a second lid (e.g., lid 65) for closing the second inlet. As shown in FIG. 4, ECU 300 automatically closes the other lid when the lid of one of the first lid and the second lid is opened and the other lid is opened (e.g., S114, S124).

In this way, it is possible to avoid a state in which the plurality of lids are opened. As a result, it is possible to prevent the user from feeling inconvenience because charging cannot be performed.

(4) As shown in FIG. 4, ECU 300 may lock the other lid after closing (e.g., S114, S124).

Accordingly, it is possible to further avoid the plurality of lids from being opened. As a result, a situation can be circumvented in which the user feels inconvenienced because charging cannot be performed.

(5) As FIG. 1 shows, the first inlet is for single-phase AC charge, and the second inlet is for both single-phase AC charge and DC charge, and the first inlet. The first inlet includes: the first terminal (for example, terminal 81) that is one of the terminals of the live terminal of single-phase AC and a neutral terminal; and the second terminal (for example, terminal 82) that is the other terminal. The second inlet includes: the 3rd terminal (for example, terminal 61) that serves as the positive terminal of DC and one terminal; and the fourth terminal (for example, terminal 62) that serves as the negative terminal of DC and another terminal. The first terminal and the second terminal are electrically connected with the third terminal and the fourth terminal, respectively (as shown by FIG. 1, the terminal 81 may be electrically connected to the terminal 61, and the terminal 82 may be electrically connected to the terminal 62).

Thus, even when the first inlet and the second inlet are conductive, the plurality of lids are prevented from being opened. Accordingly, even when charging voltage is applied to one of the first inlet and the second inlet, a situation in which the user is affected by the charging voltage applied to the other inlet can be circumvented, since the lid of the other inlet is closed.

The embodiment disclosed herein shall be construed as exemplary and not restrictive in all respects. It is intended that the scope of the disclosure be defined by the appended claims rather than the description of the embodiments described above, and that all changes within the meaning and range of equivalency of the claims be embraced therein.

What is claimed is:

1. A control device for controlling charging of a vehicle, wherein:
the vehicle includes a first inlet, a first lid for closing the first inlet, a second inlet, and a second lid for closing the second inlet; and
when one lid of the first lid and the second lid is opened, the control device places the other lid in a locked state.

2. The control device according to claim 1, wherein, when the one lid is closed, the control device places the other lid in an unlocked state.

3. A control device for controlling charging of a vehicle, wherein:
the vehicle includes a first inlet, a first lid for closing the first inlet, a second inlet, and a second lid for closing the second inlet; and
when one lid of the first lid and the second lid is opened, and the other lid is open, the control device automatically closes the other lid.

4. The control device according to claim 3, wherein the control device, following closing the other lid, places the other lid in a locked state.

5. The control device according to claim 1, wherein:
the first inlet is for single-phase alternating current charging;
the second inlet is for both single-phase alternating current charging and direct current charging;
the first inlet includes a first terminal that is one terminal of a live terminal and a neutral terminal for single-phase alternating current, and a second terminal that is the other terminal;
the second inlet includes a third terminal that serves as both a positive terminal for direct current and the one terminal, and a fourth terminal that serves as both a negative terminal for direct current and the other terminal; and
the first terminal and the second terminal electrically conduct with the third terminal and the fourth terminal, respectively.

6. The control device according to claim 3, wherein:
the first inlet is for single-phase alternating current charging;
the second inlet is for both single-phase alternating current charging and direct current charging;
the first inlet includes a first terminal that is one terminal of a live terminal and a neutral terminal for single-phase alternating current, and a second terminal that is the other terminal;
the second inlet includes a third terminal that serves as both a positive terminal for direct current and the one terminal, and a fourth terminal that serves as both a negative terminal for direct current and the other terminal; and
the first terminal and the second terminal electrically conduct with the third terminal and the fourth terminal, respectively.
